(19) United States
(12) Patent Application Publication
(10) Pub. No.: US 2002/0002580 A1
(43) Pub. Date: Jan. 3, 2002

(54) Monitoring & control of data over a network

(75) Inventor: Shimon Nurick, Tel Aviv (IL)

Correspondence Address: c/o ANTHONY CASTORINA, SUITE 207, 2001 JEFFERSON DAVIS HIGHWAY, ARLINGTON, VA, 22202, US

(73) Assignee: FIT-4-U-LTD.

(21) Appl. No.: 09/767,855

(22) Filed: Jan. 24, 2001

Related U.S. Application Data
(60) Provisional application No. 60/214,723, filed on Jun. 29, 2000.

(51) Int. Cl. G06F 15/16

(52) U.S. Cl. 709/202; 709/203; 709/206

(57) ABSTRACT

A method of personalizing and monitoring data arranged over a network, comprising: identifying a data item at a network location, adding said data item and said corresponding network location to a data tree, monitoring said data item at said corresponding network location in accordance with said instruction, to update said data item on said data tree, and presenting said updated data item to a user in accordance with said instruction.

### RELATIONSHIP TO OTHER APPLICATIONS

This application is a continuation in part of applicant's provisional application USSN 60/214,723.

### BACKGROUND OF THE INVENTION

Computer networks such as the Internet allow large numbers of computers to work together, and give an individual user access to enormous amounts of data. In general, in order for the user to be able to make any use of the data, it has to be searched and browsed. If the data changes the user has to return to the page or site of the data and browse the data again.

In order to save a user from regularly having to monitor a network location, it is known for the location to inform users that a change has been no programming connection for changes he is interested in but that the website owner has not added an automatic notification feature.

More general automatic monitoring and control of data over a network is known, and a typical application is an automated building management system in which sensors and actuators from one or more buildings are networked together, possibly using a telephone line, to a central computer where incoming data is analyzed in the light of programmed requirements, reports are produced and actuators operated. The system gives an operator at a central terminal an overall picture, at many levels of detail, of the operation of the building or group of buildings.

The application of automated monitoring and control to Internet type data is hampered by the fact that, unlike the sensor data of the building management system, most of the data available on the Internet is arranged solely for human presentation as large chunks of text or image data amongst presentational instructions. The data itself is relatively unintelligible to the computer and thus very difficult for a computer to carry out any meaningful processing to identify changes that the user might be interested in.

### SUMMARY OF THE INVENTION

According to a first aspect of the present invention there is thus provided a method of monitoring data arranged at a plurality of locations over a network comprising:

identifying a data item at a network location,

adding said data item and said corresponding network location to a data tree,

automatically monitoring said data item at said corresponding network location to update said data item on said data tree,

and allowing said user to view said data item on said data tree.

The method preferably comprises the additional step of arranging the data tree in the form of hierarchical web page entries.

A preferred embodiment comprises the step of storing the item in the data tree in association with a hypertext link to said corresponding location.

Preferably, the automatic monitoring comprises locating a software agent at said corresponding location, which software agent indicates to said data tree changes in the data item.

Preferably, a plurality of data items located at diverse locations on said network, are placeable on a single web page for monitoring together.

A preferred embodiment preferably comprises the further step of defining an alarm for alerting a user of changes in said data, wherein said alarm is set according to a condition based on the state of more than one of said plurality of data items located at diverse locations on said network.

A preferred embodiment preferably comprises the step of altering said data by entering an alteration at said data tree, and wherein said corresponding data source is automatically updated from said data tree.

Preferably, the corresponding data source is any one of a group comprising a web site including an interactive web application, a database, an interactive software suit , a monitoring and control system and any combination thereof.

Preferably, the web page type is any one of HTML, XML, SHTML, HDML, WML, ASP. DHTML, HTM and any other web page type that may be available.

According to a second aspect of the present invention, there is provided a network server comprising personalized web pages containing user defined collections of data items from a plurality of source locations on a network, at least some of said data items being updatable in response to updating of said source location.

Preferably, the source location is updatable in response to updating of said information by said user.

Preferably, the personalized web site is arrangeable within a hierarchy of web page entries.

Preferably, at least some of the data items are storable in association with a hypertext link to a corresponding source location on said network.

In one embodiment, a software agent is locatable at said corresponding source location, which software agent is able to indicate to said data tree changes in the data item.

Preferably, a plurality of data items located at diverse locations on said network, are placeable on a single web page for monitoring together.

Preferably, an alarm is definable for alerting a user of changes in said data, said alarm being settable according to a condition based on the state of more than one of said plurality of data items located at diverse locations on said network.

Preferably, the corresponding data source is any one of a group comprising an web page including an interactive web page, a database, an interactive database, a monitor and control system and any combination thereof.

Preferably, the web page is any one of the types listed above.

### BRIEF DESCRIPTION OF THE DRAWINGS

For a better understanding of the invention and to show how the same may be carried into effect, reference will now be made, purely by way of example, to the accompanying drawings, in which:

FIG. 1 is a generalized block diagram showing how numerous items of data at various sites on a network can be combined for personalized monitoring, operative in accordance with a first embodiment of the present invention,

FIG. 2 is a generalized block diagram showing elements at a user client and elements at a server, which between them are one way of providing the functionality described with respect to FIG. 1 above, and

FIG. 3 is a generalized schematic diagram showing how a server can accommodate numerous forms of data to be found on a network and can arrange it for client servers of numerous different kinds.

### DESCRIPTION OF THE PREFERRED EMBODIMENTS

Embodiments of the present invention provide a user with the ability to store diverse data items from a network on personalized and updatable web pages which have been customized for his convenience. Preferably the customized web pages allow interaction with the original data source and preferably they allow the user to be able to write data to the original data source where this is appropriate. Because this is done via the customized pages the user is not required to browse numerous web sites and other network locations in order to browse, interact with and alter the data.

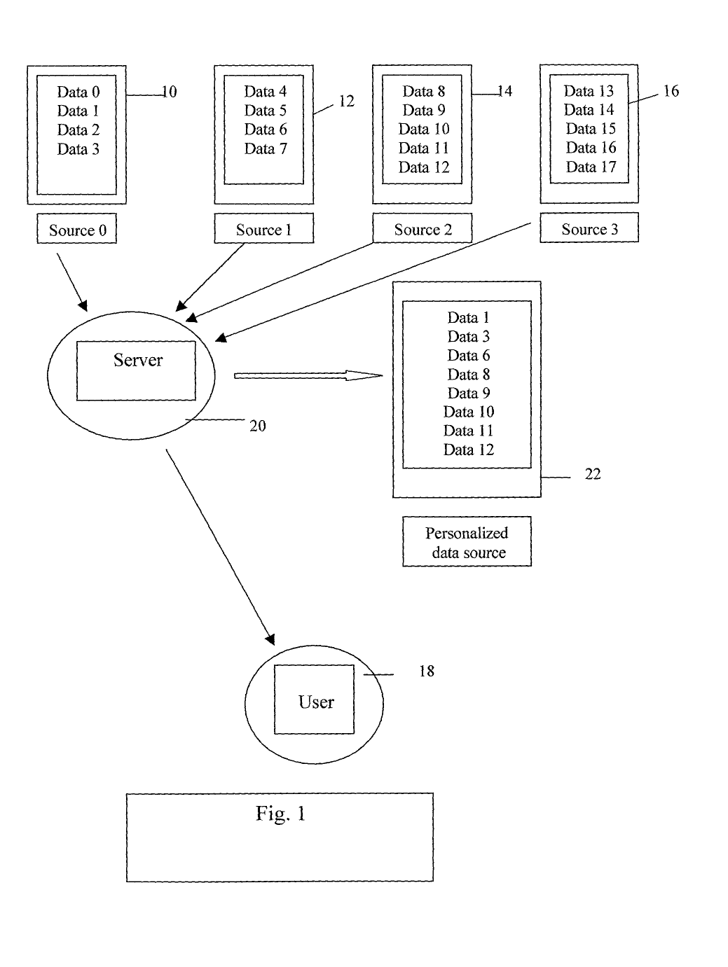

Reference is now made to FIG. 1, which is a generalized block diagram showing how numerous items of data at various sites on a network can be combined for personalized monitoring, operative in accordance with a first embodiment of the present invention. Numerous data sources, including data sources 10, 12, 14 and 16, are available over a network. Each data source has numerous data items, herein consecutively numbered, and, in the current state of the art, if a user 18 desires to browse one item from one location, three items from another and four more items from the third he has to browse each individual location. The difficulty is multiplied if he wishes to monitor all of his chosen data items on a continuous basis.

In accordance with a first embodiment of the present invention, the user 18 uses a server 20 to set up his own web page 22 with desired data items he wishes to monitor, each entry comprising the data item itself and a hypertext link to the source, enabling the web page 22 to update itself automatically at regular intervals. Thus the user is able to create a single location in which he can monitor data from diverse locations with ease. In a preferred embodiment, software agents activated at the data source may be used to determine that data has been updated and send a suitable indication to the server 20.

Preferably, alarms can be associated as desired with individual data items, allowing the user to be alerted automatically at the occurrence of a predefined event, such as a variable moving outside a given range. The types of alarms that may be set can be as complex as programming will allow, for example the quantity being monitored could be a share price, and associated data, the information being updated every quarter of an hour. The user may be interested in the price reaching above a certain level for a given amount of time but only if accompanied by a certain trading volume, and he may also be interested in the level being reached as a closing price regardless of the trading volume. An alarm could be set accordingly.

It will be appreciated that other data associated with the share price, such as the trading volume can be arranged on a single page and all the associated data can thus be monitored together automatically. An alarm may be set for conditions involving several of the data items, even though the sources of the information may be completely diverse and independent locations on the network.

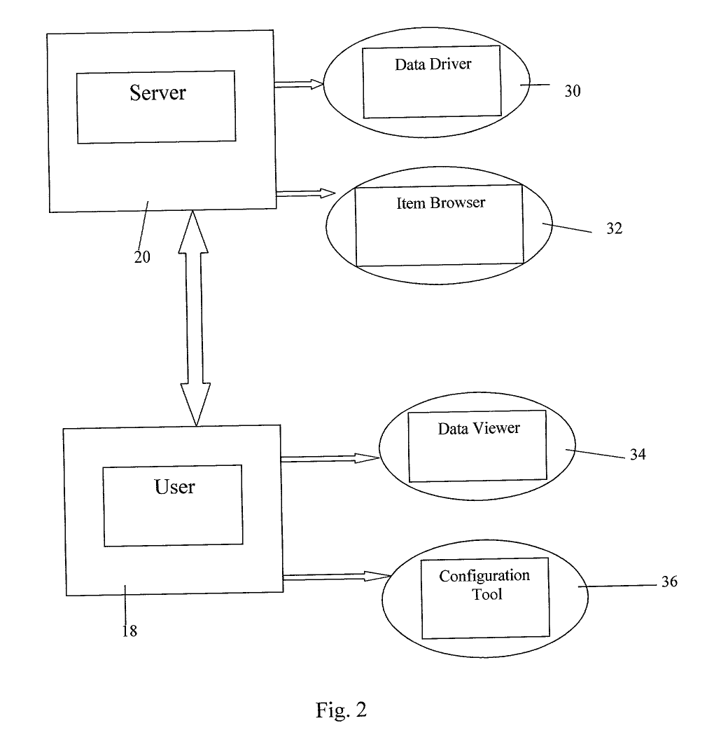

Reference is now made to FIG. 2, which is a generalized block diagram showing elements at a user client and elements at a server, which between them are one way of providing the functionality described with respect to FIG. 1 above.

The server 20 comprises a data driver 30 and an item browser 32. The server 20 preferably runs on an NT or like station and is able to support web pages. The data driver 30 is preferably a software component that retrieves data from the various selected data sources. The item browser 32 is preferably a software component that retrieves data item names from data sources. The item browser 32 thus enables the server to take advantage of XML name tags in order to identify and retrieve data.

The server preferably organizes retrieved data into the web pages mentioned above so that each user is able to peruse his own data or data belonging to a group of which he is a member.

The server uses Internet pages that run on the server side and other web pages that together comprise the server application. System configuration and definition may be may be kept in data storage, preferably as part of an SQL server or in connection with a spreadsheet application.

The web pages on the server are preferably HDML compatible so that the same pages can be seen using regular browsers and using WAP.

The user client 18 preferably comprises a data viewer 34 and a configuration tool 36. The user client 18 may run under WAP media with WML support or, alternatively it may use Internet browsers with HTML support. Thus the user is able to interrogate the system using the most convenient equipment available. The data viewer 34 allows data to be viewed, and if the data is modifiable then it will also allow the user to modify the data. Presently, in order to modify a web page it is necessary to modify a local version of the page and upload an entire modified page. The configuration tool 36 permits the user to modify an item list, meaning a hierarchical list of data items. That is to say, it enables the user to add or remove a data item that is to be monitored from the server personalized web page. In a current embodiment this feature is available only if the user client is web browser based although it may be incorporated in mobile phone based browsing systems as well.

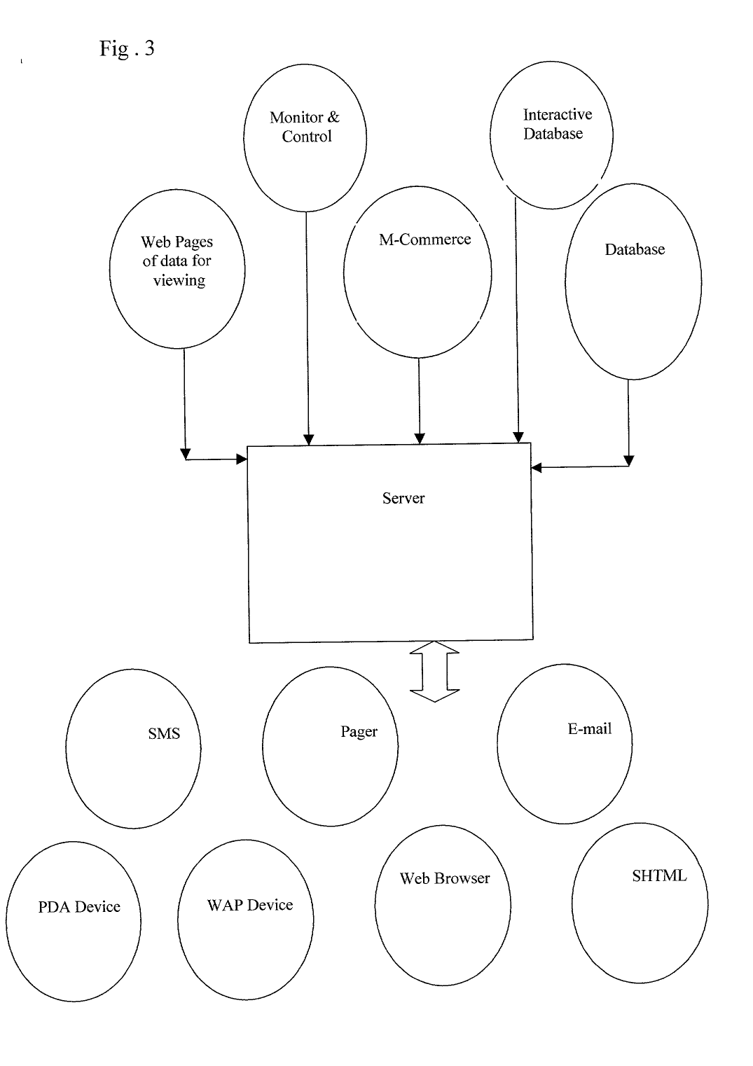

Reference is now made to FIG. 3, which is a generalized diagram of the server 20 being used as an intermediary between a plurality of types of data sources that may be available on a network and a plurality of different user clients. The data sources available on the network may be regular web pages comprising read only data in HTML format intended for browsing by human users. HTML format uses only a small number of tags for identifying the data, and the tags it uses are mainly to provide the browser with formatting information so that it is relatively difficult to provide automatic sorting of the data. Thus, although the user can identify a page he may be interested in, it is relatively difficult to provide a part of a page. In a preferred embodiment, text searches are used to search through the text for keywords specified by a user. Alternatively or additionally, a paragraph immediately following a particular title identified by the user can be incorporated into the personalized web page on the server, the server using a text search to find the title and thereby identify the following paragraph for updating.

As well as HTML and related formats, the web page may be set up using XML, which permits a wider range of tags, in particular tags that are able to label the contents of the data. If the web page is set up with XML then the server is able to identify and thus process and refresh data much more easily since it can rely on the tags.

The server can also utilize data from interactive sites such as E and M-commerce sites. The data from the commerce site would be treated in the same way as HTML data except that interaction by the user with his personalized web page allows the web page to interact in a corresponding manner with the original site.

The data may also be part of a passive or interactive database which is available on the network. In the case of an interactive database the system gives the user the opportunity to modify the database.

In addition, the server may permit interaction with a monitor and control system available over the network such as a building management system. This is achieved by presenting monitor outputs and control inputs as entries on the user's personalized web-page exactly as in previous examples.

The server 20 itself sets up the information as a browsable page. The page is preferably compatible with whatever kind of user client the user may intend. For example the user may be using a regular Internet browser, in which case the personalized page is preferably HTML. Alternatively the user may wish to view the data using an Internet compatible mobile telephone, in which case the page is preferably WAP or WML or SHTML compatible. The user may be using a palm top device. Alternatively or additionally he may want to be notified by e-mail or via pager of developments such as alarms being activated. It will be appreciated that the notification is not necessarily sent to the same device as the one he uses to set the pages or the alarm. Furthermore, the system may be used with unified messaging, allowing a notification to be sent in a predetermined order to a specified list of devices such as a mobile telephone, a pager, a fax machine etc. until a successful receipt is indicated.

The user may have his own hierarchy of personalized web pages or he may belong to a group that has its hierarchy of pages. In the case of a group, all members may have access to all pages or some members may have more access, or individual members may have access to a group contents page which leads them to their own pages. Some of the pages may be interactive in that they allow the user to interact with the web pages. This may include permitting the user to alter data at the source or to control a process. Access levels may be set by password. As mentioned above, the user may be able to alter the page hierarchy or to alter the information available on his personalized page.

One embodiment of the present invention uses P-CIM for Windows to monitor and control over the network.

An application for the present invention is for owners of websites to keep the sites up to date. In general the basic layout of a website does not get changed that frequently but certain types of data therein such as price data may need to be updated frequently. The price data may be spread over numerous pages on the site. It is not uncommon for an entire page to be devoted to an individual product, requiring updating of hundreds of pages to update prices. With the present invention a personalized web page could be constructed having a table of prices. The table could be updated by visiting a single web page and then the server 20 automatically updates all the pages on the website.

Conversely, a user may wish to track price changes of a particular product in several on-line catalogues. Again he can set up a single personalized web page with all of the prices, and set an alarm for any changes. This way he is kept automatically informed of any price changes without ever having to manually browse any of the catalogues.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

1. A method of monitoring data arranged at a plurality of locations over a network comprising:
identifying a data item at a network location,
adding said data item and said corresponding network location to a data tree,
automatically monitoring said data item at said corresponding network location to update said data item on said data tree,
and allowing said user to view said data item on said data tree.

2. A method according to claim 1, comprising the step of arranging the data tree in the form of hierarchical web page entries.

3. A method according to claim 2, further comprising the step of storing the item in the data tree in association with a hypertext link to said corresponding location.

4. A method according to claim 1, wherein said automatic monitoring comprises locating a software agent at said corresponding location, which software agent indicates to said data tree changes in the data item.

5. A method according to claim 2, wherein a plurality of data items located at diverse locations on said network, are placeable on a single web page for monitoring together.

6. A method according to claim 5, comprising the further step of defining an alarm for alerting a user of changes in said data, wherein said alarm is set according to a condition based on the state of more than one of said plurality of data items located at diverse locations on said network.

7. A method according to claim 1, further comprising the step of altering said data by entering an alteration at said data tree, and wherein said corresponding data source is automatically updated from said data tree.

8. A method according to claim 1, wherein said corresponding data source is any one of a group comprising an web page including an interactive web page, a database, an interactive database, an interactive database, a monitor and control system and any combination thereof.

9. A method according to claim 8, wherein said web page type is any one of a group comprising HTML, XML, SHTML, HDML, WML, ASP. DHTML, and HTM.

10. A network server comprising personalized web pages containing user defined collections of data items from a plurality of source locations on a network, at least some of said data items being updatable in response to updating of said source location.

11. A network server according to claim 10 wherein said source location is updatable in response to updating of said information by said user at said server.

12. A network server according to claim 10, wherein the personalized web page is arrangeable within a hierarchy of web page entries.

13. A network server according to claim 12, wherein at least some of the data items are storable in association with a hypertext link to a corresponding source location on said network.

14. A network server according to claim 10, wherein a software agent is locatable at said corresponding source location, which software agent is able to indicate to said data tree changes in the data item.

15. A network server according to claim 10, wherein a plurality of data items located at diverse locations on said network, are placeable on a single web page for monitoring together.

16. A network server according to claim 15, an alarm is definable for alerting a user of changes in said data, said alarm being settable according to a condition based on the state of more than one of said plurality of data items located at diverse locations on said network.

17. A network server according to claim 10, wherein said corresponding data source is any one of a group comprising an web page including an interactive web page, a database, an interactive database, an interactive database, a monitor and control system and any combination thereof.

18. A network server according to claim 17, wherein said web page type is any one of a group comprising HTML, XML, SHTML, HDML, WML, ASP. DHTML, HTM.
